(19) United States
(12) Patent Application Publication
(10) Pub. No.: US 2013/0328765 A1
(43) Pub. Date: Dec. 12, 2013

(54) SIGNAGE SYSTEM AND DISPLAY METHOD BY THE SAME

(71) Applicant: TOSHIBA TEC KABUSHIKI KAISHA, Tokyo (JP)

(72) Inventor: Tsuyoshi Kawamoto, Tokyo-to (JP)

(21) Appl. No.: 13/906,917

(22) Filed: May 31, 2013

(30) Foreign Application Priority Data
Jun. 12, 2012 (JP) 2012-132906

(51) Int. Cl. G06Q 30/02

(52) U.S. Cl. CPC G06Q 30/0255
USPC 345/156

(57) ABSTRACT

A signage system includes a plurality of display devices, an image capturing devices and a signage processing device. The signage processing device includes a personal recognition section for recognizing a person imaged in the image data, a data selection section for selecting a data group corresponding to the person recognized by the personal recognition section and a display control section for displaying a signage image based on the data group selected by the data selection section on the display device corresponding to the image data. The display control section displays the continuation of the signage image for the person displayed last time on the display device corresponding to the image capturing device which generates the image data if the personal recognition section recognizes the same person again according to the image data after displaying the signage image for the person on the display device.

### CROSS-REFERENCE TO RELATED APPLICATION

This application is based upon and claims the benefit of priority from Japanese Patent Application No. 2012-132906, filed Jun. 12, 2012, the entire contents of which are incorporated herein by reference.

### FIELD

Embodiments described herein relate to a signage system having a display device and method for displaying various kinds of advertisement information on the display device.

### BACKGROUND

A digital signage (also called as an electronic signboard) for selectively displaying advertisement information on a display device is being popularized in recent years.

For example, in a retail store such as a supermarket, signage images are displayed on a display device in turn to promote specific commodities at a unit of business day or at a unit of given period of time in each business day.

This method can hardly achieve a planed promotion effect if a customer watching the signage image displayed on the display device is not interested in the commodity of the signage image.

### BRIEF DESCRIPTION OF THE DRAWINGS

FIG. 1 is a configuration diagram of a signage system according to a first embodiment;

FIG. 2 is a schematic diagram illustrating the internal layout of a store in which the signage system of the first embodiment is installed;

FIG. 3 is a block diagram illustrating the main configurations of a signage server according to the first embodiment;

FIG. 4 is a diagram exemplarily illustrating the data structure of a personal authentication DB according to the first embodiment;

FIG. 5 is a block diagram illustrating the main configurations of a POS server according to the first embodiment;

FIG. 6 is a diagram exemplarily illustrating the data structure of a sales DB according to the first embodiment;

FIG. 7 is a flowchart of a customer-incoming processing according to the first embodiment;

FIG. 8 is a diagram illustrating a working area according to the first embodiment;

FIG. 9 is a flowchart of a display processing according to the first embodiment;

FIG. 10 is a flowchart of a sales registration processing according to the first embodiment; and

FIG. 11 is a flowchart of a display processing according to a second embodiment.

### DETAILED DESCRIPTION

In accordance with an embodiment, a signage system includes a plurality of display devices, an image capturing devices, respectively arranged to the plurality of display devices, which are configured to photograph each image capturing area to generate image data thereof, and a signage processing device configured to display a signage image for advertising a specific object on each display device.

The signage processing apparatus includes a personal recognition section, a data selection section and a display control section.

The personal recognition section recognizes a person imaged in the image data generated by each image capturing device. The data selection section selects a data group containing a plural signage image data corresponding to the person recognized by the personal recognition section. The display control section displays, if the person imaged in the image data is recognized by the personal recognition section, a signage image based on the data group selected by the data selection section according to the person selected on the display device corresponding to the image capturing device which generates the image data. The display control section displays, if the person is recognized by the personal recognition section again according to the image data generated by one of the image capturing devices after displaying a signage image based on the data group selected by the data selection section according to the person recognized by the personal recognition section on one of the display devices, the continuation of the signage image, based on the data group selected according to the person recognized, which is displayed on the one of the display devices last time on the display device corresponding to the image capturing device which generates the image data.

Embodiments are described below with reference to the accompanying drawings.

A signage system operating in a retail store (e.g. supermarket) is exemplarily described in the embodiments described hereinafter. However, the present invention is also applicable to a signage system operating in another kind of store such as a restaurant.

### A First Embodiment

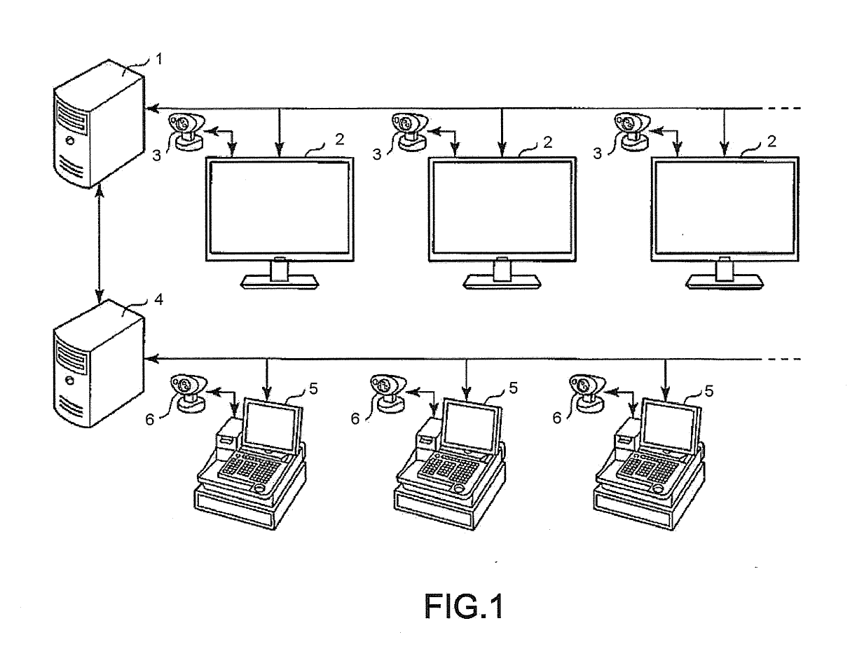

FIG. 1 is a configuration diagram of a signage system according to a first embodiment. The system comprises a signage server 1, a plurality of signage terminals 2 communicating with the signage server 1 and a plurality of cameras 3 each of which is connected with the signage terminal 2.

The signage server 1 functions as a signage processing apparatus of the present embedment. Each signage terminal 2 includes a display such as an LCD (Liquid Crystal Display) to function as a display device of the present embodiment.

In addition to the signage system, a POS (Point Of Sales) system, which comprises a POS server 4, a plurality of POS terminals 5 communicating with the POS server 4 and a plurality of cameras 6 each of which is connected with each POS terminal 5, is also operating in the subject store. The signage server 1 is connected with the POS server 4 in a mutually communicable manner. The signage system is able to operate together with the POS system through the connection. A system including the POS system can be called as a signage system. Cameras 3 and 6 function as an image capturing device according to the present embodiment.

The signage server 1 and the POS server 4 are installed, for example, in the back-office of a store. However, the signage server 1 and the POS server 4 may be installed in a headquarters, located far from the store, which manages the store.

Each signage terminal 2 and each POS terminal 5 are installed in the store. Each camera 3 is arranged nearby the signage terminal 2 communicating with the camera 3. Each camera 6 is arranged nearby the POS terminal 5 communicating with the camera 6.

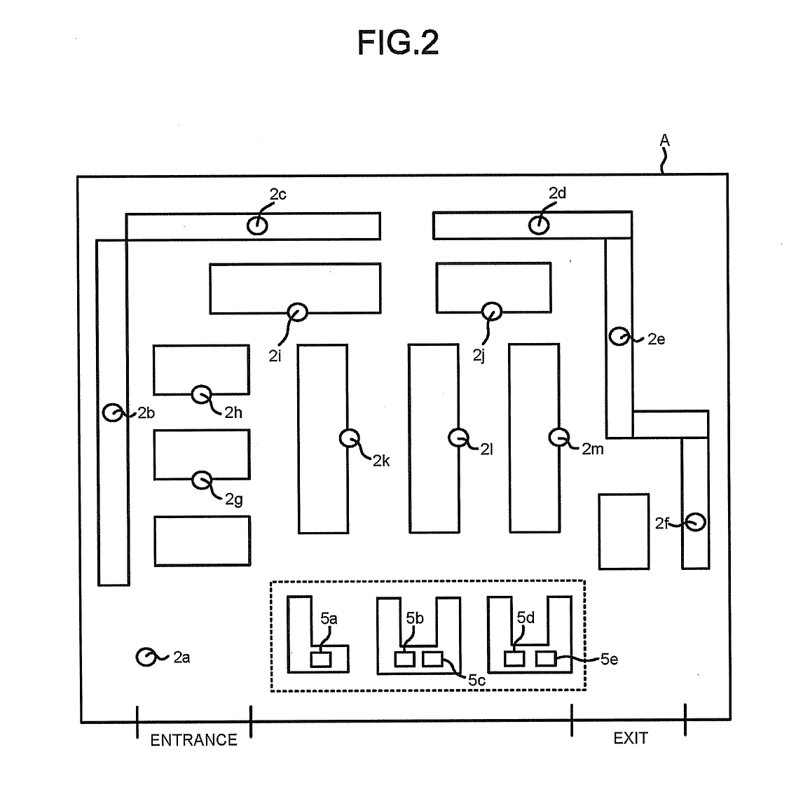

An example of arrangement of the signage terminal 2 and the POS terminal 5 is described below. FIG. 2 is a schematic diagram illustrating the internal layout of a store A in which the signage system operates. Each rectangular frame formed in a solid line in the store A represents a commodity shelf. A rectangular frame formed in a dashed line represents a checkout region. A space between each commodity shelf and the checkout region is a customer passage.

Each signage terminal 2 (2a, 2b, 2c, 2d, 2e, 2f, 2g, 2h, 2i, 2j, 2k, 2l, and 2m) is arranged in a dispersive manner at each sales area in the store such as, for example, the entrance of the store, Fruit and Vegetable Section, Meat Section, Fresh Fish Section, Deli Section, Frozen Food Section, Grocery Section and the like. The display surface of each signage terminal 2 faces a passage nearby. The image capturing area of each camera 3 is set in the direction the display surface of the signage terminal 2 connecting thereto is oriented. Messages such as ‘welcome’ and the like are displayed on the signage terminal 2a. Various signage images for advertising commodities or the store are displayed on signage terminals 2b-2m, respectively.

Each POS terminal 5 (5a, 5b, 5c, 5d, and 5e) is arranged at a checkout region. The image capturing area of each camera 6 is set in such a manner that the image capturing area covers the front image of a customer who receives checkout operation by the POS terminal 5 communicating therewith.

The signage server 1 is described below.

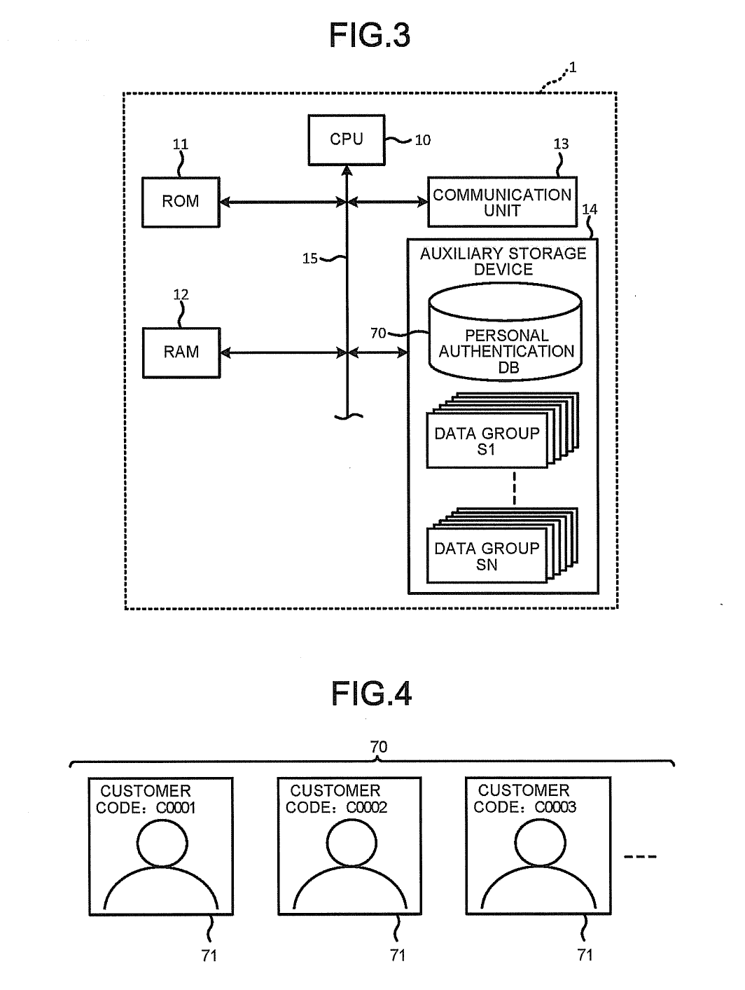

FIG. 3 is a block diagram illustrating the main constitution of the signage server 1. The signage server 1 comprises a CPU (Central Processing Unit) 10 functioning as a control center, a ROM (Read Only Memory) 11, a RAM (Random Access Memory) 12, a communication unit 13 and an auxiliary storage device 14. The CPU 10 is connected with the ROM 11, the RAM 12, the communication unit 13 and the auxiliary storage device 14 through a bus line 15 composed of an address bus line and a data bus line.

The ROM 11 stores a regular data, such as a computer program executed by the CPU 10. The RAM 12 functions as a primary storage device of the signage server 1.

The communication unit 13 communicates with the signage terminal 2 and the POS server 4 through a wired communication achieved by a communication cable or through a wireless communication achieved by radio. If the signage server 1 is arranged outside a store, a communication network such as an Internet or an intranet may be used for the communication between the communication unit 13 and the signage terminal 2 or the POS server 4.

A high-capacity storage device such as an HDD (Hard Disk Drive) or SDD (Solid State Drive) may be used as an auxiliary storage device 14. The auxiliary storage device 14 stores data relating to an OS (Operating System) or various applications, a personal authentication DB (Database) 70 and N number of data groups S1-SN (N is integer).

FIG. 4 illustrates an example of data structure of the personal authentication DB 70. The personal authentication DB 70 consists of a face image data 71 of customers who have been to the store. Unique customer codes (C0001, C0002, C003 . . . ) are respectively added to the face image data 71.

The data groups S1-SN are the set of the multiple successive signage image data to be displayed on the signage terminal 2. In the present embodiment, the data groups S1-SN are set to be data groups for regenerating signage image data at a given frame rate, that is, image data. Signage image data is used for promoting a specific object (e.g. commodity) or announcing a notice on the date of a specific sale in the store.

The POS server 4 is described below.

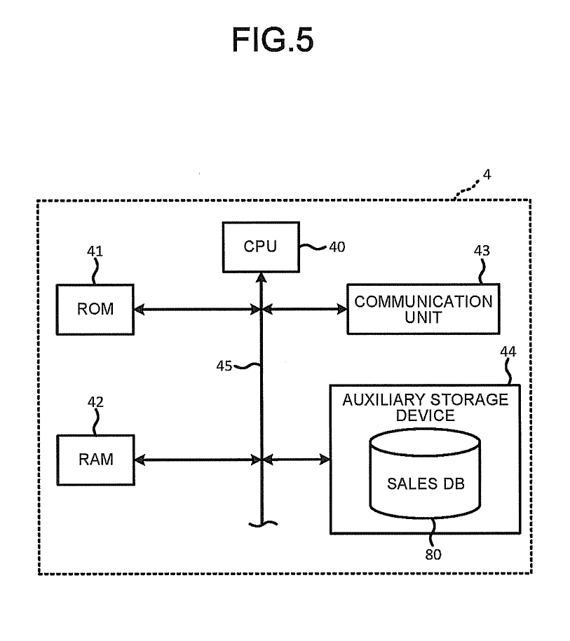

FIG. 5 is a block diagram illustrating the main constitution of the POS server 4. The POS server 4 comprises a CPU 40 functioning as a control center, a ROM 41, a RAM 42, a communication unit 43 and an auxiliary storage device 44. The CPU 40 is connected with the ROM 41, the RAM 42, the communication unit 43 and the auxiliary storage device 44 through a bus line 45 composed of an address bus line and a data bus line.

The ROM 41 stores a regular data, such as a computer program executed by the CPU 40. The RAM 42 functions as a primary storage device of the POS server 4.

The communication unit 43 communicates with the signage server 1 and the POS server 5 through a wired communication achieved by a communication cable or through a wireless communication achieved by radio. If the POS server 4 is arranged outside a store, a communication network such as an Internet or an intranet may be used for the communication between the communication unit 43 and the signage server 1 or the POS server 5.

A high-capacity storage device such as an HDD or SDD may be used as an auxiliary storage device 44, which stores data relating to an OS or various application programs and a sales DB 80.

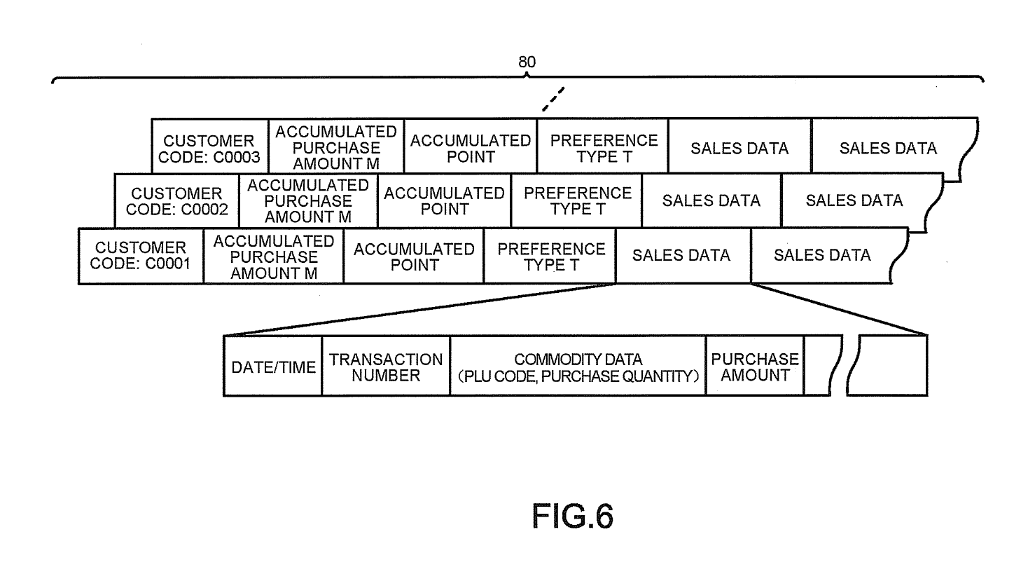

FIG. 6 illustrates an example of data structure of the sales DB 80. The sales DB 80 consists of records set for customer codes. A customer code, an accumulated purchase amount M, an accumulated point, a preference type T and one or multiple sales data (actual commodity purchase result) are written in each record. Sales data generated in each commodity transaction contains commodity data including a commodity transaction date/time, a transaction number (No.) assigned to a commodity transaction, a PLU (Price Look Up) code of commodity purchased in a commodity transaction and a purchase quantity, and a purchase amount (the amount paid in a commodity transaction). The accumulated purchase amount M is the sum of the purchase amounts contained in the sales data recorded in the records. The accumulated point is the sum of the points earned by a customer in each commodity transaction. The preference type T represents the preference of a customer relating to a commodity purchase, for example. The preference type T described in each record is predefined to be ‘preference: Japanese food’, ‘preference: Western-style food’, ‘preference: Dessert’, ‘preference: Wine’ and the like, and can select what seems to match with the actual commodity purchase result (each sales data in a record) of the customer from amongst those. This selection may be carried out according to the result of analyzing the sales data of each record performed by the POS server 4 at any given timing, or be carried out by a store clerk by referring to the sales DB 80.

Next, detailed operations of the signage system and the POS system are described.

Main operations include: a customer-incoming processing in which the customer coming to the store is recognized to prepare display of a signage image; a display processing in which the signage image for customers in the store is displayed on each signage terminal 2; and a sales registration processing in which the sales data relating to the commodity transaction settled at each POS terminal 5 is stored in the sales DB 80. The processings above are executed in parallel as occasion arise. In the present embodiment, the customer-incoming processing and the display processing are executed by the signage server 1, and the sales registration processing is executed by the POS server 4.

Following processes are carried out as a premise of execution of each processing. A real-time image data captured by each camera 3 in a given intervals is sent to the signage server 1 through the signage terminal 2 and, the CPU 10 of the signage server 1 stores the image data in the RAM 12 at any time. A real-time image data captured by each camera 6 in a given intervals is sent to the POS server 4 through the POS terminal 5, and the CPU 40 of the POS server 4 stores the image data in the RAM 42 at any time. Further, in the present embodiment, since at least a latest image data captured by cameras 3 and 6 are stored in the RAM 12 and the RAM 42, other image data is orderly deleted from the RAM 12 and the RAM 42.

Each processing is described in detail below.

[Customer-Incoming Processing]

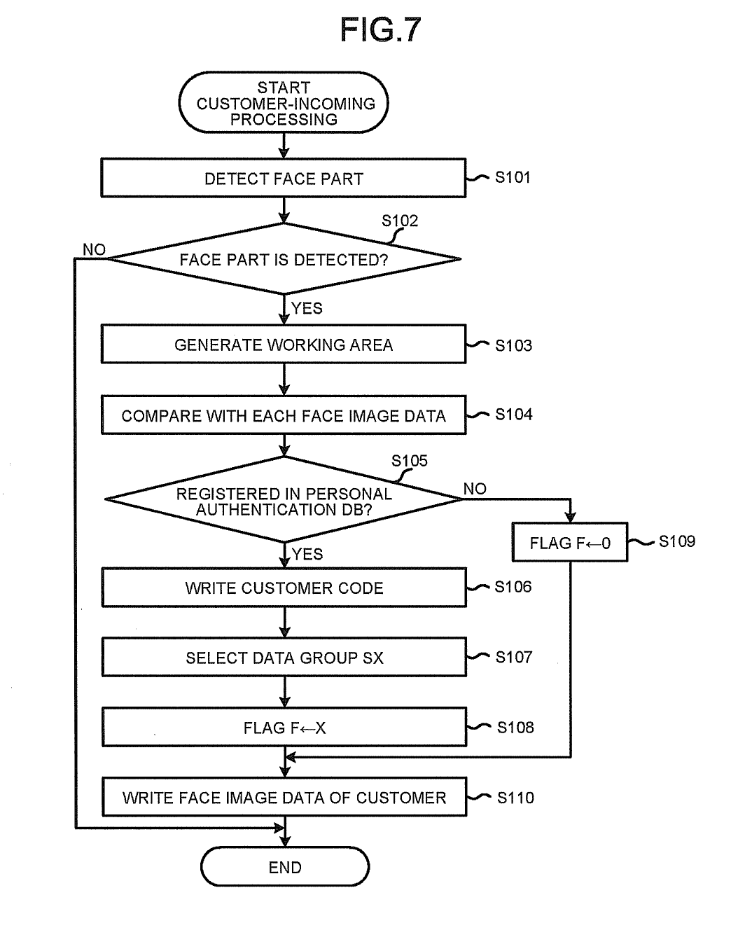

The CPU 10 of the signage server 1 executes, for example, every time the latest image data from the camera 3 connected with the signage terminal 2a (the signage terminal 2 arranged nearby the entrance) is stored in the RAM 12, the customer-incoming processing by taking the image data as an object. In the customer-incoming processing, the CPU 10 operates in accordance with the flowchart of FIG. 7 by executing a computer program for the customer-incoming processing stored in the ROM 11.

In the flowchart, first, the CPU 10 tries to detect the face part of a customer entering the store according to the image data which is generated by the camera 3 connected with the signage terminal 2a and stored in the RAM 12 (ACT S101) to determine whether or not a face part can be detected (ACT S102). For example, if the outline of a human head, and eyes, nose and mouth are recognized in the outline according to the image data, then the CPU 10 determines that the face part of the customer entering the store is detected (YES in ACT S102) and generates a working area (W) for the customer in the RAM 11 (ACT S103).

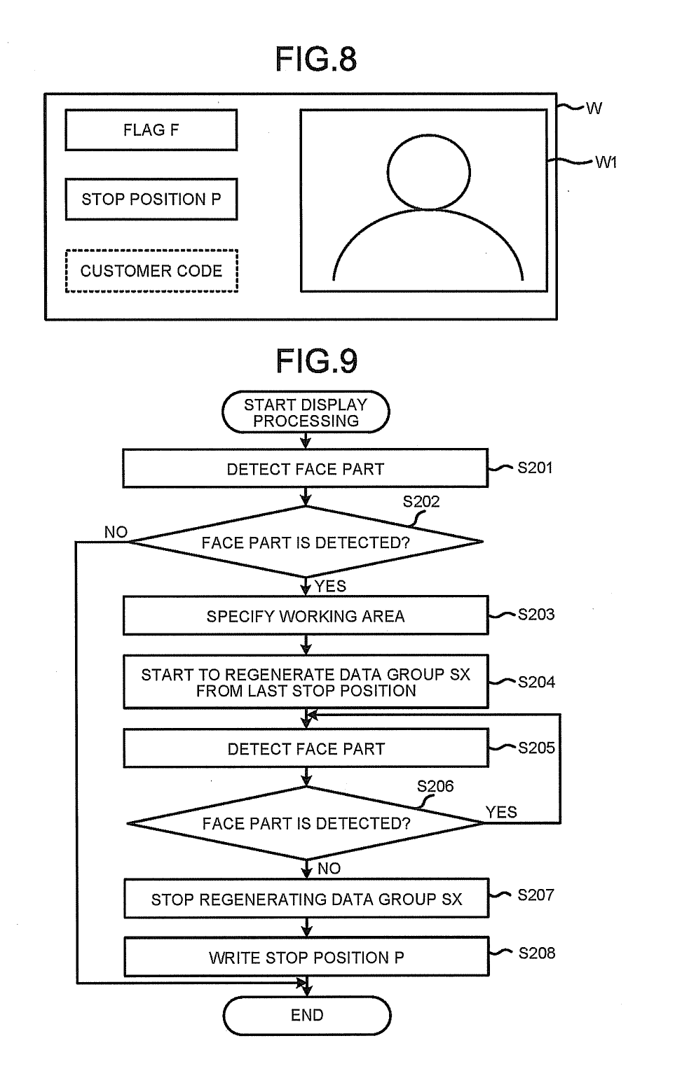

The data written in the working area W is described below with reference to FIG. 8. Face image data W1 of the customer, a flag F and a stop position P are written in the working area W. In addition, a customer code is also written in the working area W. In ACT S103, the aforementioned data is not written in the generated working area W. Functions of the flag F and the stop position P will be apparent from the following description.

After ACT S103 is executed, the CPU 10 compares the face part detected in ACT S101 with each face image data 71 stored in the personal authentication DB 70 (ACT S104) to determine whether or not the face image data of the customer having the subject face part is registered in the personal authentication DB 70 (ACT S105). In the comparison of the face image data, the CPU 10 calculates the degree of consistency of the head outlines, eyes, noses, mouths, eyebrows, ears and hairs contained in two image data of the compared objects and determines, if the degree of consistency is high enough to determine that the person is the same customer, that the face image data of the customer having the subject face part is registered in the personal authentication DB 70.

After determining that the face image data of the customer having the face part detected in ACT S101 is registered in the personal authentication DB 70 (YES in ACT S105), the CPU 10 writes the customer code assigned to the face image data 71 of the customer registered in the personal authentication DB 70 in the working area generated in ACT S103 (ACT S106).

In this way, through the processing of ACTs S104-S106, a determination is made on whether or not the customer represented by the image data is the one whose face image data is registered in the personal authentication DB 70 and the customer is recognized by the customer code if the customer is registered in the personal authentication DB 70.

The CPU 10 selects a data group SX (X is an integer within 1-N) corresponding to the preference of the customer from data groups S1-SN (ACT S107). Specifically, the CPU 10 accesses the sales DB 80 stored in the auxiliary storage device 44 of the POS server 4 through the communication unit 13 to specify the preference type T written in the record in the sales DB 80 corresponding to the customer code written in the working area W for the customer in ACT S106 and then selects, from the data groups S1-SN, a data group SX matched with the specified preference type T. For example, a table in which preference types T are associated with data groups S1-SN may be stored in the ROM 11 or the auxiliary storage device 14 in advance, and a data group matched with a preference type T is selected referring to the table.

After selecting the data group SX, the CPU 10 writes a No. X for identifying the data group in the flag F written in the working area W generated in ACT S103 (ACT S108).

On the other hand, if the face image data of the customer having the face part detected in ACT S101 is not registered in the personal authentication DB 70 (NO in ACT S105), the CPU 10 writes ‘0 (zero)’ in the flag F written in the working area W generated in ACT S103 (ACT S109).

After ACT S108 or ACT S109 is executed, the CPU 10 writes the face image data of the customer in the working area W generated in ACT S103 (ACT S110). The face image data written in the working area W is, for example, the face part detected in ACT S101 according to the image data stored in the RAM 12. Alternatively, if ACT S110 is executed following ACT S106-S108, that is, the face image data 71 of the customer is registered in the personal authentication DB 70, the face image data 71 registered in the personal authentication DB 70 may be written in the working area W.

The processing illustrated in the flowchart is ended by executing ACT S110. If no face image data is detected in ACT S102 (NO in ACT S102), then the processing illustrated in the flowchart is ended without executing ACT 5103-S110.

[Display Processing]

The CPU 10 of the signage server 1 executes the display processing illustrated in the flowchart of FIG. 9 on each signage terminal 2b-2m as an object. The processing is realized by executing the computer program stored in the ROM 11 for a display processing.

Explanation on the subject flowchart is carried out by taking the signage terminal 2b on which the subject processing is made.

First, the CPU 10 tries to detect, with reference to the image data which is generated by the camera 3 connected with the signage terminal 2b and stored in the RAM 12, the face part of the customer entering the store according to the image data (ACT S201) to determine whether or not the face part is detected (ACT S202). The detection method of the face part is the same as that in ACTs S101 and S102.

If it is determined that the face part is detected (YES in ACT S202), the CPU 10 compares the detected face part with the face image data W1 written in each working area W generated in the RAM 12 to specify the working area W for the subject customer (ACT S203). The comparison is carried out by the same method as in ACT S104. In addition, since each customer in the store enters from the entrance shown in FIG. 2, a working area W is supposed to be generally generated for the subject customer in the customer-incoming processing. However, if the camera 3 connected with the signage terminal 2a cannot generate fine face image data of the customer entering the store, there is a possibility in which the working area W for the customer is not generated. In this case, the display processing is ended as an error in the embodiment.

In this way, in the processing of ACT S203, recognition is made that the customer represented by the image data of the camera 3 corresponds to a customer of one of the working areas W generated in the RAM 12.

After specifying the working area W for the subject customer, the CPU 10 displays the signage image based on the data group SX corresponding to the value X of the flag F in the working area W on the signage terminal 2b (ACT S204). Specifically, if no stop position P is written in the working area W for the subject customer, the CPU 10 sequentially distributes the signage image data from the first sheet included in the data group SX to the signage terminal 2b or if there is a stop position P written in the working area W, the CPU 10 sequentially distributes, starting from the data at the stop position P, the signage image data included in the data group SX to the signage terminal 2b. The signage terminal 2b sequentially displays signage images based on the signage image data distributed in this way, thereby regenerating images corresponding to the data group SX.

The image data from the camera 3 connected with the signage terminal 2b is orderly stored in the RAM 12 while the signage image data included in the data group SX is sequentially distributed to the signage terminal 2b. The CPU 10 tries to detect the face part of the customer according to the image data orderly stored in the RAM 12 (ACT S205) to determine whether or not a face part is detected (ACT S206). The face part is detected in the way described in ACTs S101 and S102. If it is determined that a face part is detected (YES in ACT S206), the CPU 10 executes ACT S205 again. That is, in ACTs S205 and S206, the CPU 10 stands by until the face part of the customer cannot be detected.

If the face part of the customer cannot be detected (NO in ACT S206), the CPU 10 stops distributing the data group SX to the signage terminal 2b (ACT S207). Thus, playback of the signage image on the signage terminal 2b is terminated. Moreover, the CPU 10 writes the stop position P of playback of the signage image in the data group SX in the working area W for the customer (ACT S208). For example, the stop position P may be set to be identification information (stop time of playback) for indicating the signage image data distribution of which to the signage terminal 2b is completed within the signage image data included in the data group SX which is distributed to the signage terminal 2b.

The processing illustrated in the flowchart is ended by the execution of ACT S208. If no face image data is detected in ACT S202 (NO in ACT S202), the processing illustrated in the flowchart is ended without executing ACTs S203-S208. Then, when a new image data from the camera 3 connected with the signage terminal 2b is stored in the RAM 12, the CPU 10 executes the processing of ACT S201 again.

The CPU 10 also executes ACTs S201-S208 on the signage terminals 2c-2m.

As it can be understood from the aforementioned customer-incoming processing and display processing, the CPU 10 of the signage server 1 according to the present embedment functions as: a personal recognition section for recognizing a customer imaged in the image data generated by each camera 3 (ACT S105, S106, S203); a data selection section for selecting a data group SX corresponding to the person (customer) recognized by the personal recognition section (ACT S107); and a display control section for displaying, on the signage terminal 2 connected to the camera 3 that generates the image data, a signage image based on the data group SX selected by the data selection section according to the person recognized if the person imaged in the image data is recognized by the personal recognition section (ACT S204). Moreover, the display control section further includes processing (ACTs S204-S208), that is, after displaying the signage image on any one of the signage terminals 2 based on the data group SX selected by the data selection section according to the person recognized by the personal recognition section, the display control section displays, if the same customer is recognized by the personal recognition section again according to the image data generated by any one of the cameras 3, the continuation of last time's signage image displayed on any one of the signage terminals 2 based on the data group SX according to the customer on the signage terminal 2 corresponding to the camera 3 which generates the image data.

[Sales Registration Processing]

The POS terminal 5 executes the following processing in a commodity transaction settlement processing. The POS terminal 5 inputs, by using a barcode scanner, PLU codes of one or more commodities carried to the checkout counter by a customer to acquire commodity names, unit prices and other information based on the input PLU codes. Then, the POS terminal 5 calculates a total amount based on the information acquired, and carries out the settlement operation to issue a receipt.

After the settlement processing is ended, the POS terminal 5 sends the sales data relating to the commodity transaction that is settled, and the image data generated by the camera 6 connected with the POS terminal 5 to the POS server 4. The image data contains the face image of the customer who receives the settlement operation. In other words, the photographing timing and the photographing direction of the camera 6 are adjusted so that the image data generated by the camera 6 contains the face image of the customer.

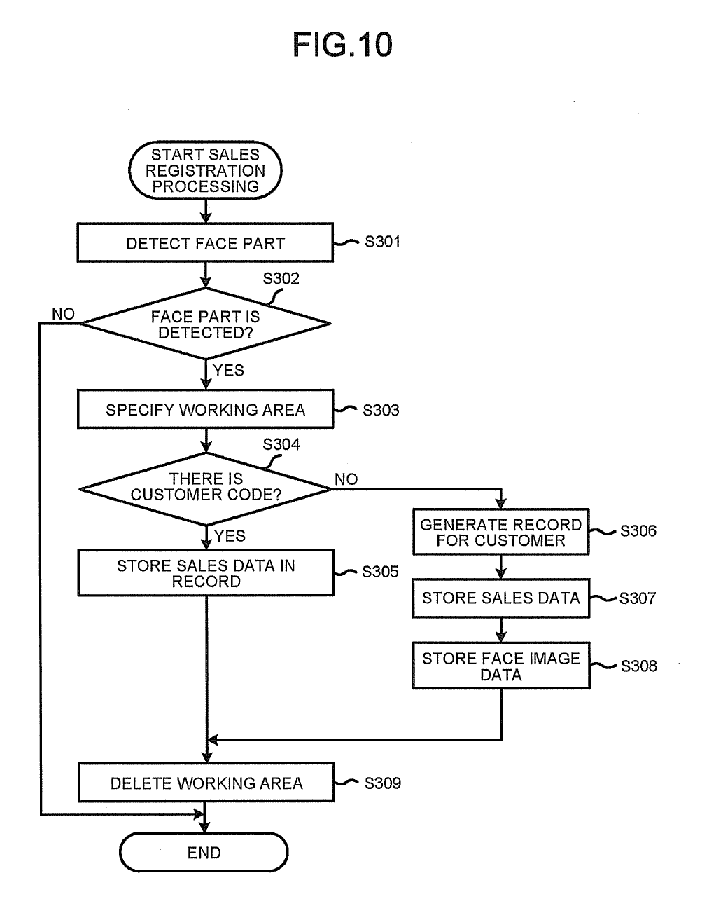

The sales data and image data sent from the POS terminal are received by the communication unit 43 of the POS server 4. The CPU 40 of the POS server 4 stores the sales data and image data in the RAM 42. Moreover, the CPU 40 executes the sales registration processing illustrated in the flowchart of FIG. 10. The processing is realized by executing the computer program stored in the ROM 41 for the sales registration processing.

In the flowchart, first, the CPU 40 tries to detect the face part of the customer who receives the settlement operation according to the image data generated by the camera 6 stored in the RAM 42 (ACT S301) to determine whether or not the face part is detected (ACT S302). The detection method of the face part is the same as that described in ACTs S101 and S102.

If it is determined that the face part is detected (YES in ACT S302), the CPU 10 compares the detected face part with a face image data W1 written in each working area W generated in the RAM 42 to specify a working area W for the subject customer (ACT S303). The comparison is carried out in the way described in ACT S104. Since each customer enters the store from the entrance shown in FIG. 2, a working area W is generally generated for the customer by the customer-incoming processing. However, if the camera 3 connected with the signage terminal 2a cannot produce fine face image data of the customer who enters the store, there is a possibility in which a working area W for the customer is not generated. In this case, the sales registration processing is ended as an error, for example.

After specifying a working area W for the customer, the CPU 40 determines whether or not a customer code is written in the working area W (ACT S304). If the customer code is written in the working area W (YES in ACT S304), a record relating to the customer is stored in the sales DB 80. At this time, the CPU 40 stores the sales data in the record, relating to the customer in the sales DB 80, that corresponds to the customer code written in the working area W (ACT S305).

On the other hand, if no customer code is written in the working area W (NO in ACT S304), the CPU 40 generates a record for the customer in the sales DB 80 (ACT S306). The CPU 40 writes a unique customer code in the record and thus this unique customer code is assigned to the subject customer.

After ACT S306 is executed, the CPU 40 stores the sales data in the record generated in ACT S306 (ACT S307). Moreover, the CPU 40 stores the face image data of the customer with the customer code for the subject customer in the personal authentication DB 70 (ACT S308).

After ACT S305 or ACT S308 is executed, the CPU 40 sends an instruction to the signage server 1 to delete the working area W for the customer (ACT S309). Upon receiving the instruction, the CPU 10 of the signage server 1 deletes the working area W for the customer from the RAM 12.

The sales registration processing is ended by the execution of ACT S309. Following the process that the sales data is added in records in the sales DB 80, it is required to update the accumulated purchase amount M and the accumulated point. Such update process may be carried out by the CPU 40 when sales data is added to a record in the sales registration processing, or by the CPU 40 when one business day is ended.

Each operation of the aforementioned processing is described in accordance with the following flow illustrating that a customer enters the store, the customer purchases commodity and leaves the store.

When a customer comes to the store, the customer is imaged, in the image data generated by the camera 3 connected with the signage terminal 2a. Thus, by detecting the face part of the customer in the customer-incoming processing (ACT S101 and, YES in ACT S102), a working area W for the customer is generated in the RAM 12 (ACT S103), and the face image data of the customer and a flag F are written in the working area W (ACTs S104-S110).

Then, the customer passes the signage terminal 2b while selecting commodities displayed. At this time, the customer is imaged in the image data generated by the camera 3 connected with the signage terminal 2b. Thus, the face of the customer is detected through the display processing executed for the signage terminal 2b (ACT S201 and, YES in ACT S202), a signage image (video) based on the data group SX corresponding to the value X of the flag F written in the working area W for the customer is displayed on the signage terminal 2b until the customer leaves from nearby the signage terminal 2b (ACTs S203-S206). When the customer leaves from nearby the signage terminal 2b and, the face of the customer cannot be recognized according to the image data generated by the camera 3 connected with the signage terminal 2b (NO in ACT S206), the display of the signage image based on the data group SX is stopped (ACT S207), and the stop position P is written in the working area W for the customer (ACT S208).

Sequentially, for example, it is assumed that the customer passes the signage terminal 2c. At this time, the customer is imaged in the image data generated by the camera 3 connected with the signage terminal 2c. Thus, the face of the customer is detected through the display processing executed for the signage terminal 2c (ACT S201 and, YES in ACT S202), a signage image (video) based on the data group SX corresponding to the value X of the flag F written in the working area W is displayed on the signage terminal 2c, starting from the stop position P written in the same working area W for the customer (ACTs S203-S206). Before long, the customer leaves from nearby the signage terminal 2c and, the face part of the customer cannot be recognized according to the image data generated by the camera 3 connected with the signage terminal 2c (NO in ACT S206). Then, the display of the signage image based on the data group SX is stopped (ACT S207), and the stop position P is written in the working area W for the customer (ACT S208).

After that, the signage image corresponding to the value X of the flag F written in the working area W for the customer is displayed in succession to the image displayed last time on the signage terminal 2 arranged at each place to which the customer goes as if the display follows the customer.

If the customer comes to the checkout counter and receives the settlement operation for the commodity transaction by the POS terminal 5a, then the sales data relating to the commodity transaction and the image data including the face part of the customer photographed by the camera 6 connected with the POS terminal 5a are sent to the POS server 4 from the POS terminal 5a. At this time, the sales data is stored in the sales DB 80 through the sales registration processing (ACTs S301-S307), and the face image data 71 of the customer is stored in the personal authentication DB 70 if the customer is a new customer (ACT S308).

In this way, according to the above constitution of the present embodiment, a signage image corresponding to a customer is displayed on a signage terminal 2 as if the display follows the customer, thus, the promotion effect brought by the signage image for the customer is enhanced.

Moreover, since the signage image displayed for each customer is a commodity image matched with the preference of the customer derived from the commodity purchase record of the customer, the promotion effect is further improved.

When the commodity transaction is settled through the POS terminal 5, the sales data relating to the commodity transaction is stored in a record in the sales DB 80 for the customer who is recognized based on the image data generated by the camera 6. Conventionally, when managing sales data of each customer, the customer is recognized by reading a medium such as a customer card and the like with a card reader. However, according to the constitution of the present embodiment, it is not required to use a medium such as a customer card and the like. Moreover, since the sales data of each customer is managed using face image data, there is no need to manage the name and the address or the mail address of a customer at the store, as a result, risk of leakage of personal information is reduced.

Additionally, if a customer is recognized in the conventional way, for example, by using a medium, the customer cannot be recognized before the POS terminal 5 begins a checkout processing. However, according to the present embodiment, each customer can be recognized when the customer comes to the store, thus, the present embodiment is extraordinary advantaged in advertisement with reference to a commodity purchased by a customer in the past during the shopping by the customer.

Other than those mentioned above also, various other excellent effects can be achieved according to the present embodiment.

### A Second Embodiment

In the construction of the first embodiment, there may be a possibility that faces of a plurality of customers are imaged at the same time in the image data of the camera 3 connected with the signage terminal 2. A method for dealing with such possibility is disclosed in the second embodiment.

Arrangements of the signage system, the POS system, the servers 1 and 4, the DBs 70 and 80 and the working area W and flows of the customer-incoming processing and the sales registration processing disclosed in this embodiment are the same as those described in the first embodiment with reference to FIG. 1-FIG. 8 and FIG. 10.

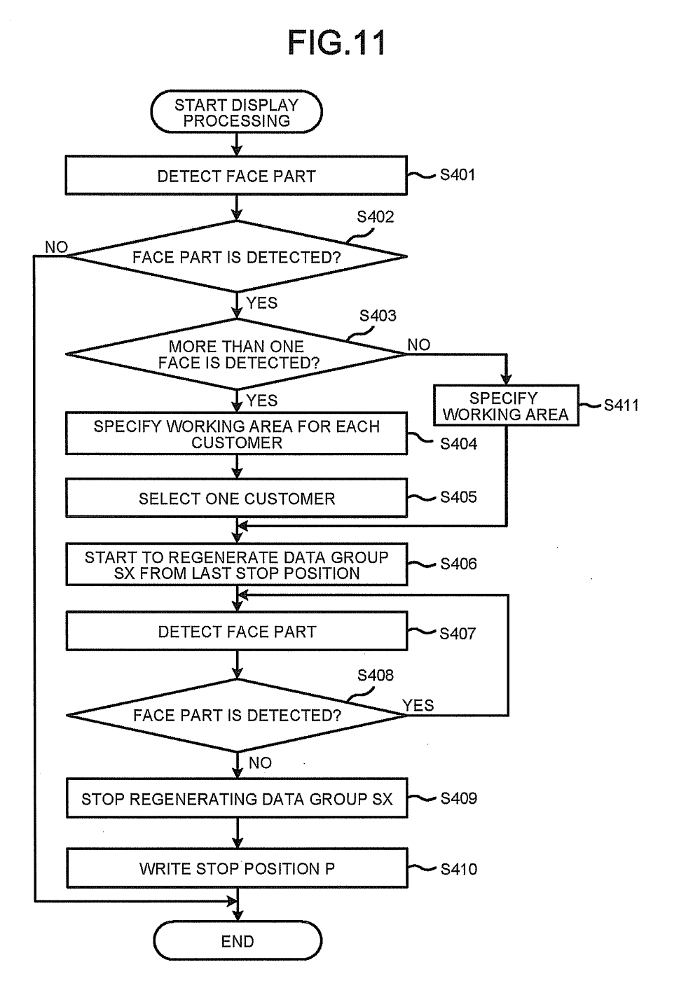

In the present embodiment, the CPU 10 of the signage server 1 executes the display processing of the flow illustrated in FIG. 11, in place of FIG. 9. That is, the CPU 10 tries to detect the face part of a customer entering the store according to the image data stored in the RAM 12 of the camera 3 connected with the signage terminal 2b (ACT S401), like in ACT S201, to determine whether or not the face part is detected (ACT S402). In the present embodiment, the CPU 10 detects all the face parts of a plurality of customers if the face parts of the plurality of customers are imaged in the image data.

If it is determined that the face part is detected (YES in ACT S402), then the CPU 10 determines whether the number of detected face part is one or more (ACT S403).

If more than one face part is detected (YES in ACT S403), the CPU 10 compares each detected face parts with face image data W1 written in each working area W generated in the RAM 42 to specify a working area W for each customer corresponding to each face part (ACT S404). The comparison is carried out in the way similar to that in ACT S104.

After specifying a working area W for each customer, the CPU 10 selects one customer from the customers as an object to whom a signage image is displayed (ACT S405). This selection may be carried out using various methods, such as a random selection method, a method of preferentially selecting the customer entering the store for the first time (a customer having no record in the sales DB 80), or a method of selecting the customer whose accumulated purchase amount M is the highest.

If a customer is selected randomly, for example, the CPU 10 generates a random number by executing a random number generation program and selects, corresponding to the random number generated, one customer from the face-detected customers as an object to whom a signage image is displayed.

If a customer entering the store for the first time is selected, the CPU 10 selects one customer, as an object to whom a signage image is displayed, corresponding to a working area W in which no customer code is written within the working areas W specified in ACT S404. If there are plural working areas W in which no customer code is written, then one customer is optionally selected from the customers corresponding to the working areas through a random number.

Furthermore, if a customer Who has a highest accumulated purchase amount M is selected, the CPU 10 accesses the POS server 4 to acquire the accumulated purchase amount M written in each record of the sales DB 80 corresponding to each customer code written in each working area W specified in ACT S404. Then, the CPU 10 selects the customer, as an object to whom a signage image is displayed, relating to the customer code corresponding to the highest accumulated purchase amount M acquired.

In this way, after selecting one customer, the CPU 10 displays a signage image based on the data group SX corresponding to the value X of the flag F in the working area W for the customer on the signage terminal 2 which is operated (ACT S406), as is similar to that in ACT S204. Then, similar to those in ACTs S205 and S206, the CPU 10 stands by until the face part of the customer cannot be detected (ACT S407, S408). If the face part of the customer cannot be detected (NO in ACT S408), the CPU 10 stops distributing the data group SX to the signage terminal 2 which is operated (ACT S409), as is similar to that in ACT S207. Thus, playback of the signage image on the signage terminal 2 which is operated is stopped. Moreover, the CPU 10 writes the stop position P of playback of the data group SX in the working area W for the customer (ACT S410), as is similar to that in ACT S208.

If it is determined in ACT S403 that there is only one customer whose face image can be detected (NO in ACT S403), the CPU 10 compares the detected face part with the face image data W1 written in each working area W generated in the RAM 42 to specify a working area W for the customer (ACT S411), as is similar to that in ACT S203. Then, the CPU 10 executes ACTs S406-S410 on the customer.

The processing illustrated in the flowchart is ended by executing ACT S410. If it is determined in ACT S402 that no face image data is detected (NO in ACT S402), the processing illustrated in the flowchart is ended without executing ACTs S403-S411.

As is apparent from the aforementioned display processing, in addition to the operation sections described in the first embodiment, the CPU 10 of the signage server 1 of the present embodiment also functions as a person selection section which selects one person from a plurality of persons if the personal recognition section recognizes the plurality of persons from one image data (ACT S405).

According to the display processing of the present embodiment, even if a plurality of customers are imaged in the image data of the camera 3, a specific customer can be selected from the plurality of customers and the signage image of the specific customer is displayed on the signage terminal 2 connected with the camera 3.

Especially, if a method for selecting a customer who has a highest accumulated purchase amount M is adopted as a method for selecting one customer, it is expected that an extraordinary promotion effect can be achieved because an advertisement of a commodity and the like can be preferentially provided to the customer who makes a high contribution to the sales of the store.

Additionally, the effect similar to that achieved in the first embodiment can certainly be achieved in the present embodiment.

### Modification

The constitution disclosed in each embodiment above may be modified appropriately.

For example, data groups S1-SN are not necessarily images (video). In addition to images, the data group (S1-SN) may be the set of multiple still image data for displaying a signage image (still image) corresponding to each sales place on the signage terminal 2 (2b-2m) arranged at each sales place. In this case, each still image data may be used to promote the commodities displayed in the sales place or guide a customer from one sales place to another sales place (an arrow indicating the direction to another sales place).

Further, the signage server 1 may determine a customer attribution (male, female, child and like) according to the image data of each camera 3 and select one from a data groups S1-SN using the determined attribution, instead of a preference type T or using the attribution along with the preference type T. To determine a customer attribution, a great amount of face image data attribution of which are well known, such as an age and a sex, are collected in advance, the correlation between the shapes and the positions of the parts (head outline, eye, nose, mouth, eyebrow, ear, hair line and wrinkle) contained in the collected face image data and each known attribution is statistically calculated, and the resulting data is formed into a database and then stored in the ROM 11. Then, the attribution of a customer is deduced by comparing the shapes and the positions of the parts contained in the face of the customer imaged in the image data of the camera 3 with the data stored in the database. Further, the attribution of a customer imaged in the image data may be determined according to the feature of the clothing or the height of the customer.

In the second embodiment, in the case in which a plurality of customers is imaged in the image data, one customer is selected from the customers as a display object of a signage image. However, the screen of the signage terminal 2 is segmented according to the number of the customers, and signage images for customers may respectively be displayed on the segmented screens at one time.

Further, it is not needed to store the computer programs for the customer-incoming processing, the display processing and the sales registration processing in the ROM 11 or the ROM 41 in advance. Same programs may be downloaded to the signage server 1 or the POS server 4 from a network. Alternatively, same programs recorded in a recording medium may also be installed in the signage server 1 or the POS server 4. The form of the recording medium is not limited as long as the recording medium can store programs like a CD-ROM and a memory card and is readable by an apparatus. Further, the function realized by an installed or downloaded program can also be achieved through the cooperation with an OS installed in the apparatus.

The customer-incoming processing and the display processing executed by the CPU 10 of the signage server 1 as described above may be partially or completely executed by the signage terminal 2 to reduce the processing workload of the signage server 1.

A single server may take roles of both the signage server 1 and the POS server 4. Moreover, the customer-incoming processing, the display processing and the sales registration processing may be realized through cloud computing. In this case, a cloud system having a plurality of servers is connected in communication with the signage system and the POS system and part of the processing executed by the signage server 1 and the POS server 4 may be taken by the cloud system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A signage system including a plurality of display devices, an image capturing devices, respectively arranged to the plurality of display devices, which are configured to photograph each image capturing area to generate image data thereof, and a signage processing device configured to display a signage image for advertising a specific object on each display device, wherein
the signage processing device includes a personal recognition section configured to recognize a person imaged in the image data generated by each image capturing device, a data selection section configured to select a data group containing a plural signage image data corresponding to the person recognized by the personal recognition section and a display control section configured to display, if the person imaged in the image data is recognized by the personal recognition section, a signage image based on the data group selected by the data selection section according to the person recognized on the display device corresponding to the image capturing device which generates the image data, and
wherein the display control section displays, if the person is recognized by the personal recognition section again according to the image data generated by one of the image capturing devices after displaying a signage image based on the data group selected by the data selection section according to the person recognized by the personal recognition section on one of the display devices, the continuation of the signage image, based on the data group selected according to the person recognized, which is displayed on the one of the display devices last time on the display device corresponding to the image capturing device which generates the image data.

2. The signage system according to claim 1, further including:
a settlement processing device configured to settle a commodity transaction;
an image capturing device, connecting to the settlement processing device, which is configured to photograph an image area including a person who receives the settlement by the settlement processing device to generate the image data; and
a database configured to store information relating to the commodity transaction settled by the settlement processing device as an actual commodity purchase result of the person in the image data generated by the image capturing device.

3. The signage system according to claim 2, wherein
the data selection section selects the data group containing the signage image data, which is derived from the actual commodity purchase result of the person recognized by the personal recognition section stored in the database, to advertise a commodity matched with the preference of the person recognized by the personal recognition section.

4. The signage system according claims 1, further including:
a person selection section configured to select one person from a plurality of persons if the personal recognition section recognizes the plurality of persons from one image data captured, wherein
the data selection section selects the data group for the person selected by the person selection section.

5. The signage system according to claim 4, wherein
the person selection section selects a person whose purchase amount accumulated in the past commodity transactions is the highest from the plurality of persons recognized by the personal recognition section.

6. A method for displaying a signage image by a signage processing device, including a plurality of display devices configured to display a signage image for advertising a specific object and an image capturing devices, arranged to each display device, which are configured to photograph an image capturing area to generate image data, that is used in a signage system, including:
recognizing a person imaged in the image data generated by each image capturing device;
selecting a data group containing a plural signage image data corresponding to the person recognized;
displaying, on the display device corresponding to the image capturing device which generates the image data, a signage image based on the data group selected for the person if the person imaged in the image data is recognized; and
displaying, if the person is recognized again according to the image data generated by one of the image capturing devices after displaying the signage image based on the data group selected according to the person recognized on one of the display devices, the continuation of the signage image, based on the data group selected according to the person recognized, which is displayed on the one of the display devices last time on the display device corresponding to the image capturing device which generates the image data.
